(19) United States
(12) Patent Application Publication
(10) Pub. No.: US 2012/0058444 A1
(43) Pub. Date: Mar. 8, 2012

(54) Variable Extension Spring For Orthodontics

(76) Inventor: Timothy J. Allesee, St. Charles, IL (US)

(21) Appl. No.: 13/042,189

(22) Filed: Mar. 7, 2011

Related U.S. Application Data
(60) Provisional application No. 61/311,125, filed on Mar. 5, 2010.

(51) Int. Cl. A61C 7/00

(52) U.S. Cl. 433/21; 433/24

(57) ABSTRACT

A variable extension spring with two anchoring ends. Each anchoring end connected to an anchoring mechanism having engagement mechanisms. Engagement mechanisms may be eyelets. Engagement of the engagement mechanisms to intraoral features at different engagement positions allows variability in the extension length of the spring. Such variability allows the user to adjust the force exerted by the spring on the intraoral features. As intraoral features move overtime due to the force exerted by the spring, the extension length of the spring may change. Adjustment of the spring extension length is accomplished by engaging a different engagement mechanism to provide an engagement position that will extend the spring the desired length. The user is able to reduce inventory by being able to use the same spring several times to provide a desired range of forces for adjusting orthodontia.

This application claims the benefit of U.S. Provisional Application No. 61/311,125 filed on Mar. 5, 2010.

### FIELD OF THE INVENTION

This invention relates to the field of orthodontics, in particular an orthodontic coil spring.

### BACKGROUND OF THE INVENTION

Orthodontic coil springs are used to provide force to move individual teeth or segments of teeth. Coil springs most often contain attachment mechanisms, or “eyelets” which are designed to allow the ends of the coil spring to be attached to posts on brackets, archwires, temporary anchorage devices (TADs) or any other intraoral feature.

Coil springs are commonly made from stainless steel, nickel-titanium, and other suitable materials and are typically designed to be extended to two to three times their original length upon clinical activation. Coil springs are most often available in a variety of lengths, internal lumens and wire diameters to accommodate a multitude of clinical situations that are well known to an orthodontic practitioner. For example, a shorter spring will be useful when moving an individual tooth or segments of teeth a short distance whereas a longer spring will be useful for moving the dentition a larger distance. Different types of teeth or groupings of teeth also require different levels of force to move in the manner desired by the clinician. The force used to move a patient's teeth must be great enough to allow for proper alignment, yet not exert too great a force to cause damage to or misalignment of the tooth or adjacent dentition. In cases where there is space between adjacent teeth, a coil spring may be used to bring the teeth closer together. Various internal lumens of the spring or actual wire diameters are well known to impart more or less force on the dentition. Each end of the coil springs is attached to stop fittings on adjacent teeth, archwires or suitable attachments. The force of the spring imparts a force to move the teeth toward each other or, when sufficient anchorage exists, one individual tooth into a predetermined space.

As individual teeth or groups of teeth are pulled towards each other, the extended distance of the coil spring decreases, most often resulting in a corresponding decrease of the force exerted on the teeth by the spring. In order to maintain a suitable force to move the teeth, the coil spring is replaced with a new, usually shorter, spring to exert appropriate force when the amount of movement eliminates the usefulness of the initial spring length.

Conventional coil springs provide only a single eyelet of various shapes and sizes on either end of the spring for attachment. The springs are therefore limited by the amount of extension that will be employed to create the optimal amount of clinical rebound force. A clinician must therefore maintain a relatively large inventory of spring lengths, lumens and/or wire diameters to meet varying clinical situations.

The present inventor has recognized the need for a multipurpose spring which decreases inventory requirements.

The present inventor has recognized the need for a spring which is capable of multiple uses for individual patients.

The present inventor has recognized the need for a spring design that allows the clinician to select the appropriate amount of force imparted to the dentition.

The present inventor has recognized the need for a spring which decreases the treatment time of a patient.

### SUMMARY OF THE INVENTION

A variable extension spring for orthodontics having at least one end of the spring with multiple engagement positions corresponding to different extension lengths of the spring is provided.

In one embodiment, the variable extension spring comprises a coil spring with two anchoring ends. The coil spring connects to an anchoring mechanism at each anchoring end. The anchoring mechanism comprises a spring attachment region wherein the coil spring becomes attached to the anchoring mechanism. The spring attachment region is disposed at one end of the anchoring mechanism. In this embodiment, the spring attachment region comprises two channels through which coils of the spring are wound to securely connect the coil spring to the anchoring mechanism.

Each anchoring mechanism comprises at least one engagement mechanism, such as an eyelet. Other suitable engagement mechanisms known to one skilled in the art, such as hooks, may also be used. At least one of the anchoring mechanisms comprises more than one engagement mechanism. Each engagement mechanism is disposed at an engagement position.

In use, the orthodontist identifies an engagement position, which when engaged with a post on a bracket for example, exerts a desired level of force to pull teeth towards each other. As the teeth move toward each other over time, the original distance the spring is stretched decreases. Tooth movement eventually ceases, as the spring no longer retains sufficient force to overcome resistance. These force requirements will vary depending on the size of the individual crown, arch length, distance between teeth to be moved, or the number of teeth being moved as a group. To readjust the force exerted on the teeth, the orthodontist disengages the post from its engagement with the first engagement mechanism at the first engagement position, and selects a second engagement mechanism which provides a second engagement position, for example, the engagement mechanism adjacent to the first engagement mechanism, to provide a second appropriate force which is exerted on the teeth to move the teeth toward each other.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates an exemplary embodiment of a variable extension spring.

FIG. 1A illustrates the variable extension spring of FIG. 1 extended between two anchors in a patient's mouth.

FIG. 1B illustrates the variable extension spring of FIG. 1 engaging with an engagement mechanism adjacent to that of the one engaged in FIG. 1A after the outermost engagement mechanism has been removed.

FIG. 2A illustrates another exemplary embodiment of the variable extension spring comprising an anchoring mechanism with two engagement mechanisms.

FIG. 2B illustrates other exemplary embodiments of the variable extension spring comprising an anchoring mechanism with three non-equidistantly disposed engagement mechanisms.

FIG. 2C illustrates other alternative exemplary embodiments of the variable extension spring comprising at least two engagement mechanisms on each anchoring mechanism.

FIG. 2D illustrates another exemplary embodiment of the variable extension spring comprising anchoring mechanisms each with three engagement mechanisms on each end.

FIG. 2E illustrates other embodiments of the variable extension spring comprising engagement mechanisms of different sizes on either end of the coil spring.

FIG. 3 illustrates a perspective view of an anchoring mechanism.

FIG. 4 illustrates a perspective view of an alternate embodiment of the anchoring mechanism.

FIG. 4A illustrates yet another embodiment of the anchoring mechanism.

FIG. 4B illustrates another alternate embodiment of the anchoring mechanism.

FIG. 5 illustrates a top view of the anchoring mechanism of FIG. 3.

FIG. 6 illustrates a top view of an alternate anchoring mechanism with differently sized engaging mechanisms.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

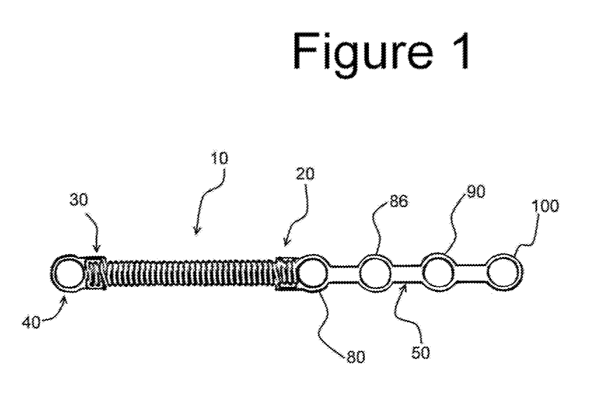

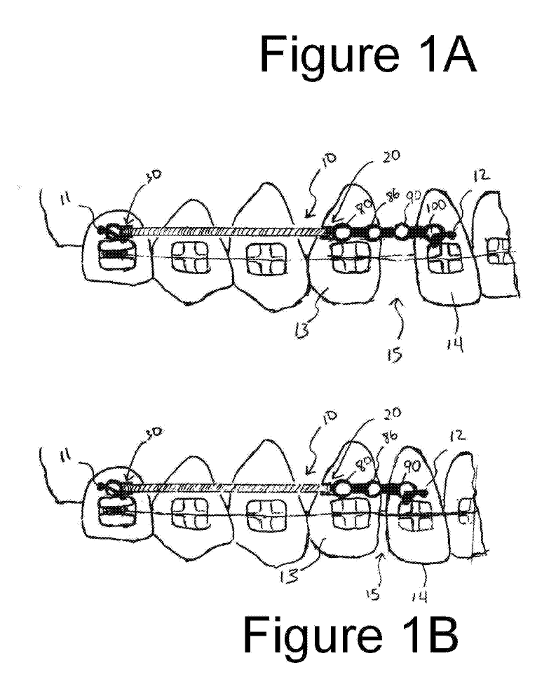

FIG. 1 illustrates an exemplary embodiment of the variable extension spring. The variable extension spring comprises a coil spring 10, with two anchoring ends 20, 30. The two anchoring ends 20, 30 are respectively attached to anchoring mechanisms 40, 50.

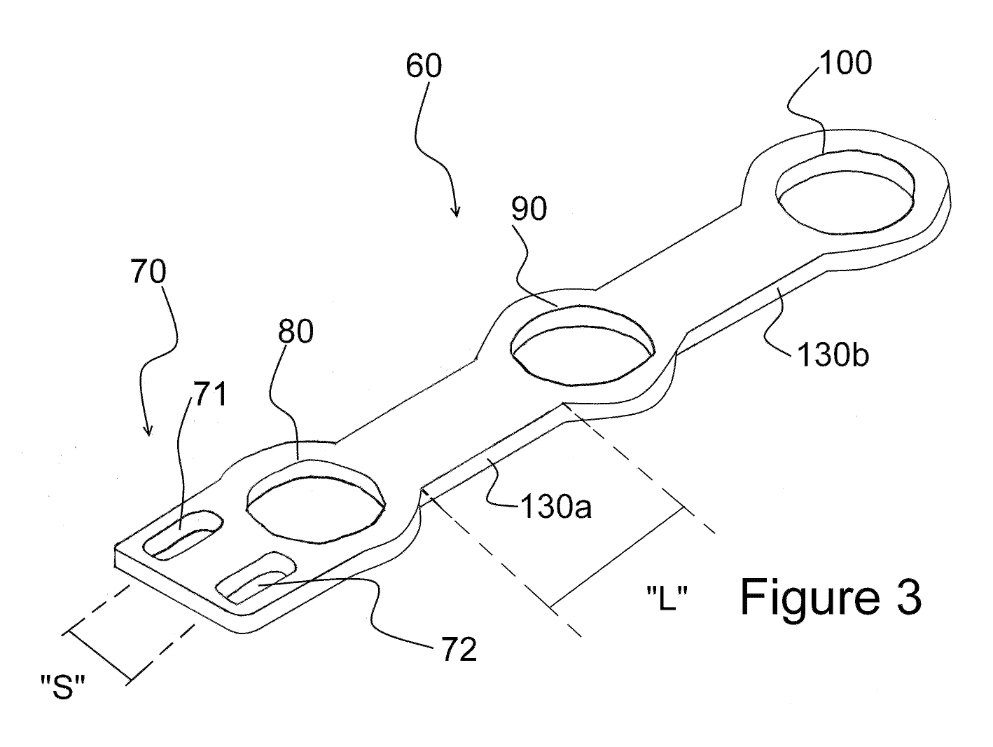

The anchoring mechanism 50 comprises engagement mechanisms 80, 86, 90, 100. Anchoring mechanism 60 as illustrated in FIG. 3 comprise engagement mechanisms 80, 90, 100. At least one of the anchoring mechanisms comprises more than one engagement mechanism. FIG. 1A illustrates the variable extension spring of FIG. 1 extended between two anchors 11, 12 in a patient's mouth to move teeth 13, 14 towards each other.

The coil spring 10 may configured as be a tension spring or a compression spring. The coil spring may be made of stainless steel, nickel titanium, beta titanium, or other suitable alloys which provide adequate shape memory. Coil springs of various expansion capabilities, such as 6 mm, 9 mm, and 12 mm springs, may be used to exert the desired force on teeth. This generally depends on the span between teeth to be moved or the desired amount of space closure required for successful completion of the procedure. Each anchoring end 20, 30 of the coil spring 10 is connected to an anchoring mechanism at its spring attachment region 70 (FIG. 3).

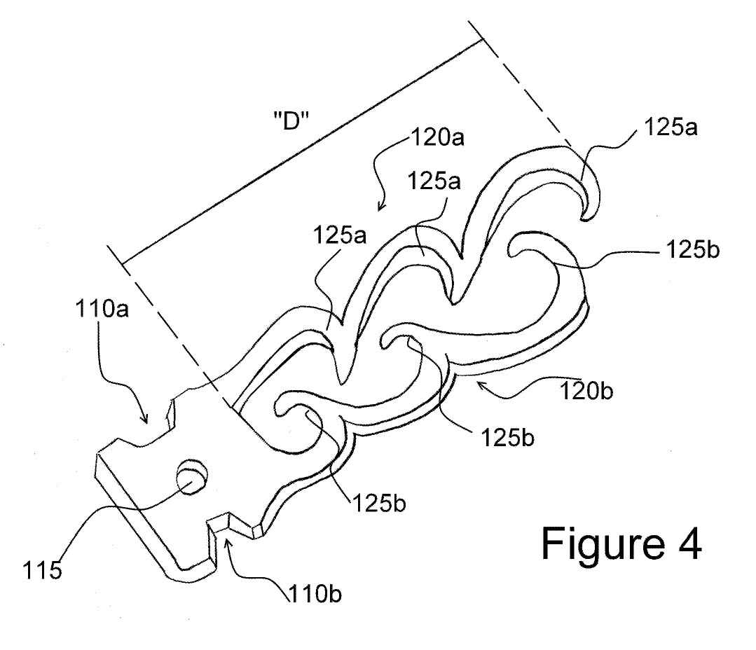

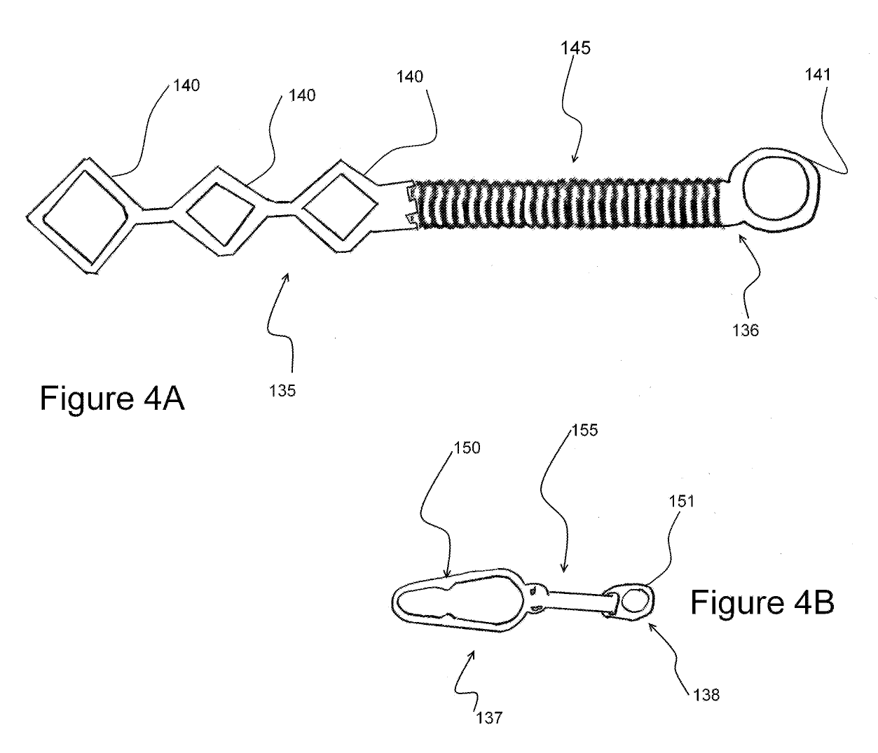

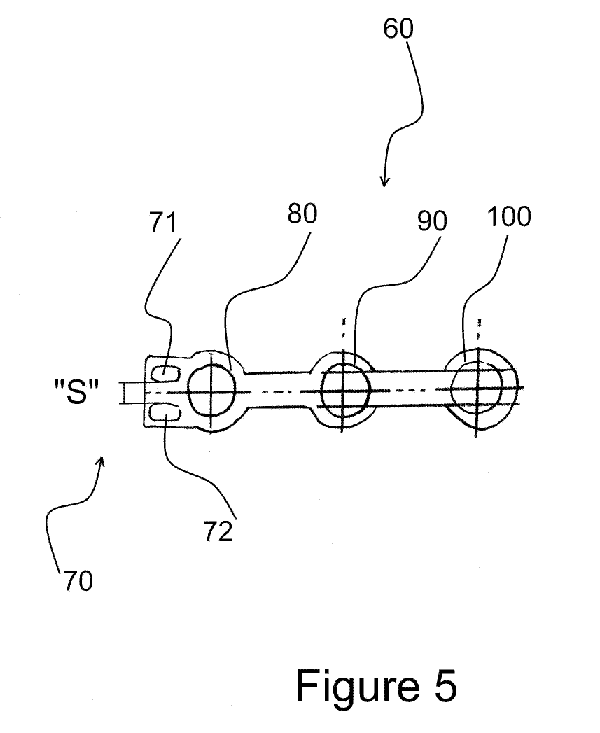

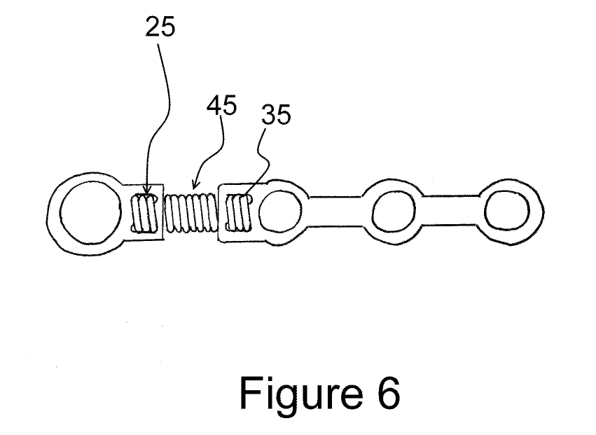

FIG. 3 illustrates an anchoring mechanism 60. The anchoring mechanism 60 may be made from the same or different material as the coil spring. The anchoring mechanism 60 can be made from ductile material, such as 304 or 302 series stainless steel that can be cut using dental cutting instruments. The anchoring mechanism 60 comprises a spring attachment region 70, and at least one engagement mechanism 80, 90, 100. The spring attachment region 70 can comprises two channels 71, 72 spaced a distance “S” apart (FIG. 5), through which the anchoring ends of the coil spring is wound to attach the anchoring mechanism to the anchoring end of the coil spring. The channels 71, 72 are spaced apart a distance S such that the coil radius at the anchoring ends 25, 35 (FIG. 6) is consistent with the coil radius at the body 45 of the coil spring 15. Alternatively, the channels can be spaced a distance S apart such that the radius of the coil at the anchoring end when wounded though the channels 71, 72, is greater or smaller than the radius of the body of the coil spring. Other types of spring attachment regions known to one skilled in the art can also be used to connect the anchoring ends of the coil spring to the anchoring mechanisms. For example, as illustrated in FIG. 4, the spring attachment region can comprise a hole 115 and notches 110a, 110b for attachment to an anchoring end of the coil spring. In another embodiment, the spring attachment region allows the anchoring mechanism to rotate about an axis parallel to the longitudinal axis of the coil spring. The anchoring mechanism may rotate about an axis in line with the longitudinal axis of the coil spring. Anchoring ends 25, 35 of the spring may be engaged to allow the anchoring mechanism and the coil spring to swivel with respect to each other. Alternatively, in yet another embodiment, the spring attachment region allows for the anchoring ends 25, 35 to engage with the anchoring mechanism such that the anchoring mechanism may rotate about an axis perpendicular to the longitudinal axis of the coil spring.

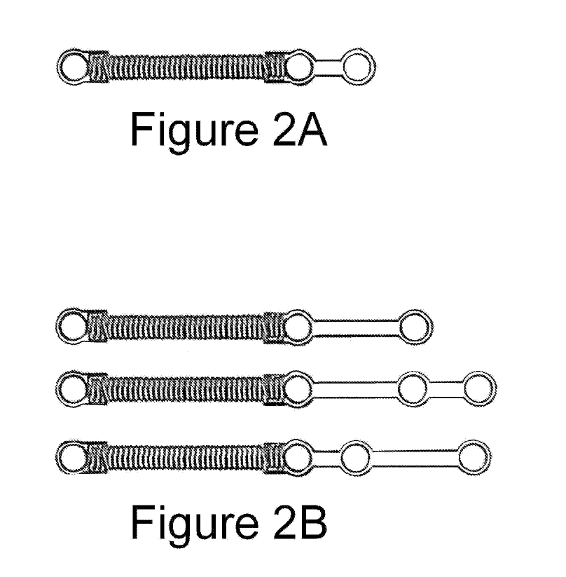

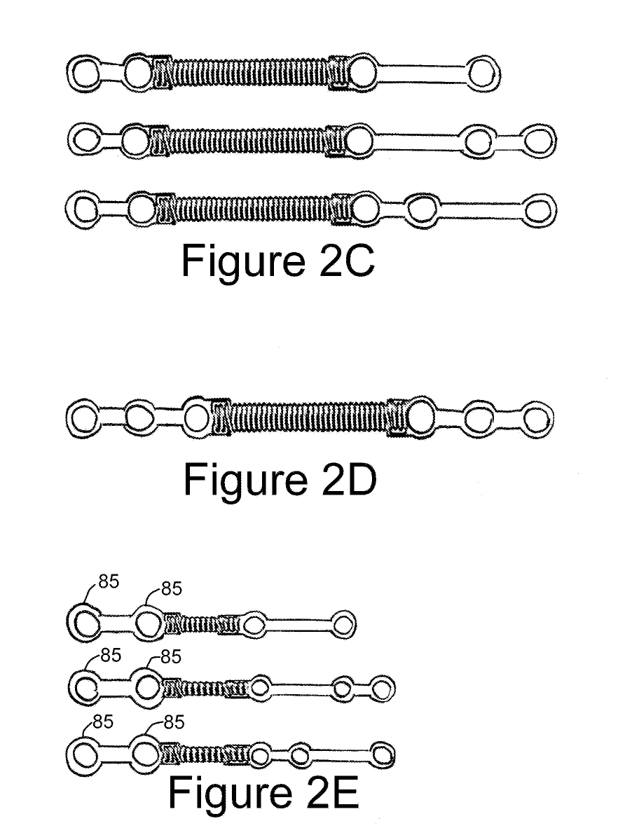

In the embodiment illustrated in FIG. 3, the spring attachment region 70 extends from an adjacent engagement mechanism. The anchoring mechanism comprises three engagement mechanisms 80, 90, 100. The engagement mechanisms can be eyelets as illustrated, or may be any other suitable engagement mechanism such as a bracket, hook or eyelets of various shapes or internal diameters. In use, each engagement mechanism 80, 90, 100 provides a corresponding engagement position. For example, engagement mechanism 100 provides a first engagement position, and engagement mechanism 90 provides a second engagement position. The engagement mechanisms illustrated in FIG. 3 are spaced equidistant from each other, with bridges 130a, 130b connecting the engagement mechanisms 80, 90, 100 in series. Alternate arrangements for the engagement mechanisms are illustrated in FIGS. 2A-2E. FIG. 2A illustrates a variable engagement spring comprising two engagement mechanisms on one of the anchoring mechanisms. FIG. 2B illustrates embodiment of the variable extension spring comprising three non-equidistantly disposed engagement mechanisms on one of the anchoring mechanisms. FIG. 2C illustrates a variable extension spring with at least two engagement mechanisms on each anchoring mechanism. FIG. 2D illustrates a variable extension spring comprising three engagement mechanisms on each anchoring mechanism. FIG. 2E illustrates a variable extension spring comprising differently sized engagement mechanisms. A larger engagement mechanism 85 may be used on one side of the coil spring to adapt for use with a temporary anchoring device or TAD (not shown). In one embodiment, the larger engagement mechanism 85 can have an inner diameter of 0.088″ (2.235 mm), and an outer diameter of a suitable size to appropriately engage with the TAD.

In another embodiment, as illustrated in FIG. 5, the anchoring mechanism may be about 0.01″ (0.254 mm) in thickness, with an inner eyelet diameter of 0.058″ (1.473 mm), and an outer eyelet diameter of 0.088″ (2.235 mm).

The bridge portions 130a, 130b span a distance “L” as illustrated in FIG. 3. Distance L should be of a sufficient length to allow for a cutting instrument to be positioned between two adjacent engagement mechanisms, such that the engagement mechanism(s) furthest away from the coiled spring may be disconnected from the rest of the anchoring mechanism when the engagement position(s) is no longer needed, but may also be of a shorter or longer distance.

In the alternative embodiment illustrated in FIG. 4, the engagement mechanism uses a hook-type mechanism 125a, 125b. The anchoring mechanisms can comprise one row of engagement mechanisms 125a, or may have engagement mechanisms aligned in a pair of offset rows 120a, 120b, such that more engagement positions are provided within the same distance span “D”. Additional alternative embodiments, illustrated in FIGS. 4A, and 4B show that the engagement mechanisms can be any shape, including non-symmetrical shapes, to better accommodate the various types of hooks or TAD's. FIG. 4A illustrates an anchoring mechanism 135 with diamond-shaped engagement mechanisms 140 on one end of a coil 145 having an anchoring mechanism 136 on the opposite end comprising a circular eyelet 141. FIG. 4B illustrates an anchoring mechanism 137 with an oblong eyelet 150 on one end of a coil 155 having an anchoring mechanism 138 on the opposite end comprising a circular eyelet 151.

In use, an orthodontist selects a variable extension spring with the appropriate coil spring expansion capability and anchoring mechanism to provide an appropriate number and spacing of engagement mechanisms. The location of the engagement mechanism corresponds to engagement positions which provide predetermined increments of force. For example, engaging an outermost engagement mechanism 100 in FIG. 1 will exert less force on teeth than engaging the engagement mechanism 90 immediately adjacent. An orthodontist may select the correct engagement mechanism with which to begin treatment, and simply detach, if any, outer engagement mechanisms beyond the engagement mechanism selected. Alternatively, an orthodontist may select a variable extension spring wherein the outermost engagement mechanism 180 corresponds to the correct engagement position to provide the desired force. The distance between engagement mechanisms is also selected by the orthodontist in anticipation of the gradual movement of teeth as a result of the force of the spring exerted on the teeth between visits to the orthodontist office. As illustrated in FIG. 1A, a variable extension spring with engagement mechanisms 80, 86, 90, and 100 is selected for use. The anchor 12 on teeth 14 engages with the outermost engagement mechanism 100. Engagement mechanism 90 is adjacent to engagement mechanism 100.

As treatment progresses, the force exerted by, for example, a tension spring such as the one illustrated in FIG. 1A, causes teeth to move closer. As teeth move toward each other, the extension length, and correspondingly the force exerted by the spring on the teeth, decreases. A patient returns at the next appointment to readjust the spring to exert a desired force, such as the one provided by the adjacent engagement mechanism 90, as illustrated in FIG. 1B. Engagement mechanism 100 is removed by the orthodontist, leaving engagement mechanism 90 as the outermost engagement mechanism. Switching to engagement mechanism 90 for use with the anchor 12 allows more force to be exerted on the teeth 14 than engagement mechanism 100 in light of the movement of the teeth 14 over time, as indicated by the narrower gap 15 between teeth 13 and 14 in FIG. 1B as compared to FIG. 1A.

By having the anchoring mechanism provide more than one engagement position by way of having multiple engagement mechanisms, the orthodontist is able to adjust the force exerted on adjacent teeth by selecting a different engagement position, without having to replace the entire spring. The orthodontist is also able to select a variable extension spring that provides a suitable distance between the engagement mechanisms based on the force exerted by the spring and the anticipated movement of the teeth as a result of the force exerted by the spring on the teeth, to determine the time needed between visits to readjust the engagement mechanism. Alternatively, if a patient desires a certain time frame in the future for a next visit, the orthodontist may select a variable extension spring based on the factors above, to suit the patient's schedule. The demonstrated versatility of the variable extension spring allows for the user to reduce inventory, as a wider range of functions are able to be addressed with a fewer number of springs. Furthermore, time spent by the orthodontist adjusting the force exerted on the spring is decreased as the orthodontist need only disengage the previous engagement mechanism, and select a second engagement mechanism to provide the engagement position with the desired force. The user can then remove, by cutting, the engagement mechanism that provided the first engagement position, or the engagement mechanism beyond which engagement positions are no longer useful to provide the desired force.

Some specific types of nickel titanium coil springs exhibit “superelastic” properties versus the more common variable force properties. Superelasticity denotes a relatively constant force regardless of the range of extension. Superelastic springs may, however, lose these properties if they are overextended. Superelastic springs will also lose their ability to move teeth once they return to or near their original shape. Conventional superelastic springs cannot be “reactivated” via multiple eyelets to overcome these limitations. However, having multiple eyelets for use with coil springs made of superelastic material provides the user with the benefit of reducing inventory. An orthodontist has the option of selecting the appropriate engagement mechanism with which to begin treatment, and simply detach, if any, outer engagement mechanisms beyond the engagement mechanism selected. Inventory is reduced because one variable extension spring can provide the orthodontist multiple extension distances from which a distance for beginning treatment can be selected.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A variable engagement spring for orthodontics comprising:
a coil spring;
a first anchoring mechanism disposed on one end of the coil spring, said first anchoring mechanism comprising at least one engagement mechanism; and
a second anchoring mechanism disposed on the opposite end of the coil spring, said second mechanism comprising at least two engagement mechanisms.

2. The variable engagement spring of claim 1 wherein the engagement mechanisms on the first and second anchoring mechanisms are eyelets.

3. The variable engagement spring of claim 1 wherein the engagement mechanisms on the first and second anchoring mechanisms are the same size.

4. The variable engagement spring of claim 1 wherein at least two engagement mechanisms are of different size.

5. The variable engagement spring of claim 1 having at least three engagement mechanisms on at least one of the first or second anchoring mechanisms, said at least three engagement mechanisms evenly spaced apart from each other.

6. The variable engagement spring of claim 1 having at least three engagement mechanisms on at least one of the first or second anchoring mechanisms, said at least three engagement mechanisms are unevenly spaced apart from each other.

7. The variable engagement spring of claim 1 wherein the number of engagement mechanisms on the first and second anchoring mechanisms are equal.

8. The variable engagement spring of claim 1 wherein the number of engagement mechanisms on the first and second anchoring mechanisms are not equal.

9. A method for exerting force on dentition comprising the steps of:
using a coil spring connected to anchoring mechanisms on either end of the coil spring, one anchoring mechanisms having at least one engagement mechanism, one anchoring mechanism providing at least two engagement mechanisms, each engagement mechanism corresponding to an engagement position;
selecting a spring with a suitable extension length; and
providing a force on dentition exerted by the spring.

10. The method of claim 9 wherein the step of providing a force on dentition comprises the steps of:
determining the desired force to be exerted;
determining the spring extension length corresponding to the desired force;
selecting a pair of engagement positions provided by engagement mechanisms on either end of the coil spring to provide the spring extension length corresponding to the desired force;
engaging a first engagement mechanism providing one of the pair of engagement positions to a first intraoral feature; and
engaging a second engagement mechanism providing the desired engagement position to a second intraoral feature.

11. The method of claim 10 further comprising the step of removing outer engagement mechanisms.

12. The method of claim 10 further comprising the step of adjusting the force exerted by the spring after a pre-determined amount of time has elapsed.

13. The method of claim 12 wherein the step of adjusting the force exerted by the spring comprises the steps of:
disengaging one or more engagement mechanisms from a intraoral feature; and
reengaging the intraoral feature with a different engagement mechanism.

14. The method of claim 13, further comprising the step of removing outer engagement mechanisms providing unused engagement positions.

15. The method of claim 10 wherein at least one intraoral features is a post.

16. The method of claim 10 wherein one of the intraoral features is a temporary anchorage device.

17. The method of claim 10 wherein the intraoral features are each located on a tooth.

18. A method for providing a force between two intraoral features, at least one intraoral feature being disposed on dentition to be moved, comprising the steps of:
providing a select coil spring; and
adjusting the amount of force exerted by the select coil spring between the two intraoral features after the spring extension length has decreased over time.

19. The method of claim 18 further comprising the step of;
engaging a first pair of engagement mechanisms on either end of the select coil spring at appropriate engagement positions provided by the engagement mechanisms, to the intraoral features to provide a desired spring extension length corresponding to the desired amount of force between the two intraoral features; and wherein
the step of adjusting the amount of force comprises the step of engaging a second pair of engagement mechanisms on either end of the select coil spring at appropriate engagement positions to increase the spring extension length, said second pair of engagement mechanisms having at least one engagement mechanism providing a different engagement position than one of the first pair of engagement mechanisms.

20. The method of claim 19 further comprising the step of removing an engagement mechanism from the select coil spring.
